(19) United States
(12) Patent Application Publication
(10) Pub. No.: US 2024/0263046 A1
(43) Pub. Date: Aug. 8, 2024

(54) Crosslinkable Compositions

(71) Applicant: 3M INNOVATIVE PROPERTIES COMPANY, St. Paul, MN (US)

(72) Inventors: Hyunki Kim, Woodbury, MN (US); Jason D. Clapper, Lino Lakes, MN (US); Andrew T. Swanson, St. Paul, MN (US); Eric W. Nelson, Stillwater, MN (US); Chun-Yi Ting, Taoyuan City (TW); Hollis Z. Beagi, Stillwater, MN (US)

(21) Appl. No.: 18/290,359

(22) PCT Filed: May 12, 2022
(86) PCT No.: PCT/IB2022/054435

§ 371 Date: Nov. 13, 2023

Related U.S. Application Data
(60) Provisional application No. 63/190,094, filed on May 18, 2021.

(51) Int. Cl. C09J 7/38

(52) U.S. Cl. CPC C09J 7/385; C09J 2301/302; C09J 2301/414; C09J 2301/416; C09J 2433/00

(57) ABSTRACT

Crosslinkable compositions including a (meth)acrylate polymer comprising an alkyl (meth)acrylate monomer; an acylphosphine oxide photoinitiator; and a crosslinking monomer, the crosslinking monomer comprising at least two terminal groups selected from the group consisting of allyl, methallyl, or combinations thereof. Methods of preparing such crosslinkable compositions and articles including such crosslinkable compositions are disclosed.

### BACKGROUND

In electronic devices, e.g., electronic display devices, pressure sensitive adhesives (“PSAs”) are commonly used to bond a cover glass or lens to the underlying display module of the electronic device, bond the touch sensor to the cover glass and the display, or bond the lower components of the display to the housing. The pressure-sensitive adhesives used in these electronic devices may be optically clear adhesives (“OCAs”).

The presence of an OCA can improve the performance of a display device, for example, by increasing brightness and contrast, while also providing structural support to the assembly. For these applications (commonly referred to as electronics bonding, or e-bonding), both the PSAs and the OCAs should have sufficiently high strength of adhesive force to properly maintain good adhesion to components, not only when the electronic devices are operating under normal conditions, but also when they are subjected to traumatic forces or extreme environmental conditions.

### SUMMARY

Disclosed herein are multifunctional allyl crosslinkers which may be used, for example, in UV-absorbing, acrylic optically clear adhesives (“OCAs”), such as those commonly used in electronic display devices. The disclosed crosslinkers, when used in an acrylic polymer system, i.e. a crosslinkable composition, may desirably provide an efficient pathway to enable both the photopolymerization process to generate the OCA as well as a latent curing mechanism to be accessed once the OCA has been integrated into the electronic display device. This type of two-step curing process advantageously allows for a dichotomy of OCA material properties during different stages of the integration and lifespan of the electronic device.

In one aspect, provided are crosslinkable compositions comprising a (meth)acrylate polymer comprising an alkyl (meth)acrylate monomer, an acylphosphine oxide photoinitiator, and a crosslinking monomer, the crosslinking monomer comprising at least two terminal groups selected from the group consisting of allyl, methallyl, or combinations thereof.

In another aspect, provided are adhesives including the disclosed crosslinkable compositions, as well as articles incorporating such adhesives.

As used herein:

The term “and/or” such as in the expression “A and/or B” means A alone, B alone, or both A and B.

The term “crosslinkable composition” refers to the reaction mixture that may be crosslinked. The crosslinkable composition may include polymerizable components plus any other material, such as, for example, a free radical initiator, a chain transfer agent, an antioxidant, a solvent, and the like that may be included in the reaction mixture.

The term “curable” means that a solid material can be transformed into a more crosslinked solid by means of stimuli induced crosslinking.

The term “gel fraction” as used herein refers to the mass fraction of the network material resulting from a network-forming polymerization and/or crosslinking process.

The term “(meth)acryloyl” refers to a group of formula CH₂═CR—(CO)— where R is hydrogen (for an acryloyl group) or methyl (for a methacryloyl group).

The term “(meth)acrylate” refers to a methacrylate and/or acrylate. Likewise, the term (meth)acrylic acid” refers to methacrylic acid and/or acrylic acid and the term “(meth)acrylamide” refers to methacrylamide and/or acrylamide. Likewise, the term “(meth)allyl group” refers to a methallyl group and/or an allyl group.

The term “polymer” means homopolymers, copolymers, terpolymers, and the like.

The term “polymerizable component” refers to a compound that can undergo polymerization (i.e., the compound has a polymerizable group). The polymerizable component typically has an ethylenically unsaturated group such as a (meth)acryloyl-containing group or a vinyl group that is the polymerizable group. The compounds that have a polymerizable group can be referred to as a “monomer”.

The term “pressure-sensitive adhesive” or “PSA” is used in its conventional manner according to the Pressure-Sensitive Tape Council, which states that pressure-sensitive adhesives are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Central to all PSAs is a desired balance of adhesion and cohesion that is often achieved by optimizing the physical properties of the elastomer, such as glass transition temperature and modulus. For example, if the glass transition temperature (T_{g}) or modulus of the elastomer is too high and above the Dahlquist criterion for tack (storage modulus of 3×10⁶ dynes/cm² at room temperature and oscillation frequency of 1 Hz), the material will not be tacky and is not useful by itself as a PSA material.

The term “glass transition temperature”, which can be written interchangeably as “T_{g}”, of a monomer refers to the glass transition temperature of the homopolymer formed from the monomer. The glass transition temperature for a polymeric material is typically measured by Dynamic Mechanical Analysis (“DMA”) at the maximum in tan delta (δ).

The term “vinyl” refers to a polymerizable component that has a group CH₂═CH— but that is not part of a (meth)acryloyl group.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful and is not intended to exclude other claims from the scope of the disclosure.

In this disclosure, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all the listed elements or a combination of any two or more of the listed elements.

Also, herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also, herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “room temperature” refers to a temperature of 20° C. to 25° C. or 22° C. to 25° C.

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

When a group is present more than once in a formula described herein, each group is “independently” selected, whether specifically stated or not. For example, when more than one R group is present in a formula, each R group is independently selected.

Reference throughout this specification to “one embodiment,” “an embodiment,” “certain embodiments,” or “some embodiments,” etc., means that a specific feature, configuration, composition, or characteristic described in connection with the embodiment is included in at least one embodiment of the invention. Thus, the appearances of such phrases in various places throughout this specification are not necessarily referring to the same embodiment of the invention. Furthermore, the specific features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the disclosure, guidance is provided through lists of examples. These examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

Features and advantages of the present disclosure will be further understood upon consideration of the detailed description as well as the appended claims.

### DETAILED DESCRIPTION

Some advantages of using an optically clear adhesive (“OCA”) in optoelectronic devices may include, inter alia, an enhancement of the light extraction efficiencies between various optical components of the display and reduction of light scattering by mitigating refractive index mismatches at interfaces. As topographical features of optoelectronic device structures evolve into more complex geometries, there is an increasing demand for the development of highly compliant OCAs that can both adjust to these complex geometries as well as mitigate optical defects. However, once OCA film is integrated into the display, the OCA material should also be mechanically robust for the lifetime of the device in order to provide high mechanical stability and performance. One method of balancing these potentially opposing manufacturing requirements is through the use of a two-step UV curing process. Such two-step processes may allow for the UV process generation of an OCA having significant viscous character for compliance during lamination steps, followed by a UV-driven increase in the crosslinking density of the OCA after integration with the device.

For some applications, it may also be desirable for an OCA material to utilize UV-absorbing additives to protect any UV-sensitive components underneath the OCA layer. For example, hydroxyphenyl benzotriazole-based UV absorbers (e.g., TINUVIN 928 commercially available from BASF, Florham Park, New Jersey), which show high absorption below 380 nm wavelength of light, may be incorporated into OCAs to block UV light from reaching light-sensitive layers adjacent to the adhesive. However, this UV-absorbing function may intervene with one or both of the UV-based processes used to 1) generate the OCA; and 2) post-cure the OCA after lamination. The UV absorber in the OCA may block not only UV exposure from an end-user's environment but may also block a significant portion of the UV spectrum used during the manufacturing of both the adhesive and display device. Reduced access to the post-lamination curing process not only limits the adhesive's ability to balance compliance with robust lifetime reliability but may also limit the adhesive and mechanical performance attributes of the OCA in general. Therefore, there is a need for technological development in OCA materials to incorporate UV-blocking functionality while retaining access to photopolymerization and photocuring mechanisms.

The present disclosure provides UV-absorbing and post-lamination curable OCA films produced using a scheme that takes advantage of a combination of rapidly polymerizing acrylic monomers in conjunction with more slowly reacting crosslinker compounds. This scheme allows for greater separation between the polymerization and crosslinking functions of the adhesive without requiring multiple wavelength emission equipment, while concurrently allowing for the achievement of both functions in the presence of UV absorber additives. Advantageously, a crosslinking reaction may be carried out in the latter stage of conversion with a similar wavelength band of light as was used for the acrylic polymerization reactions.

### Crosslinkable Composition

In one aspect, provided is a crosslinkable composition including a (meth)acrylate polymer comprising an alkyl (meth)acrylate monomer, a phosphine oxide-type photoinitiator, and a crosslinking monomer, the crosslinking monomer comprising at least two terminal groups selected from the group consisting of allyl, methallyl, or combinations thereof.

Crosslinkable compositions of the present disclosure may be cured, for example, by exposure to actinic radiation. The gel fraction for the crosslinkable composition may be calculated both before and after such curing as described in the Examples section infra. In some preferred embodiments, the gel fraction of the crosslinkable composition before curing is 0.2 to 0.8, 0.3 to 0.75, or 0.4 to 0.7 In some preferred embodiments, the change in gel fraction of the crosslinkable composition after curing is greater than 0.03, greater than 0.04, greater than 0.05, or greater than 0.06.

### (Meth)Acrylate Polymer

The (meth)acrylate polymer can be prepared from polymerizable components including an alkyl (meth)acrylate monomer using known polymerization methods.

### Alkyl (Meth)Acrylate Monomers

Any suitable alkyl (meth)acrylate or mixture of alkyl (meth)acrylates can be used provided the glass transition temperature of the final (meth)acylate polymer is sufficiently low (e.g., no greater than 20° C.). Some alkyl (meth)acrylate monomers can be classified as low T_{g} monomers based on the glass transition temperature of the corresponding homopolymers. The low T_{g} monomers, as measured from the corresponding homopolymers, often have a T_{g} no greater than 20° C., no greater than 10° C., no greater than 0° C., or no greater than −10° C.

Suitable low T_{g} alkyl (meth)acrylate monomers include, but are not limited to, non-tertiary alkyl acrylates but can be an alkyl methacrylate having a linear alkyl group with at least four carbon atoms. Specific examples of alkyl (meth)acrylates include, but are not limited to, methyl acrylate, ethyl acrylate, n-propyl acrylate, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, n-dodecyl methacrylate, and combinations thereof. In some embodiments, the low T_{g} alkyl (meth)acrylates is selected from 2-ethylhexyl acrylate, isooctyl acrylate, n-butyl acrylate, 2-methylbutyl acrylate, 2-octyl acrylate, and combinations thereof. Other suitable monomers include branched long chain acrylates, such as those described in U.S. Pat. No. 8,137,807 (Clapper, et al.). Additional suitable alkyl monomers include secondary alkyl acrylates, such as those described in U.S. Pat. No. 9,102,774 (Clapper, et al.).

Other alkyl (meth)acrylates that can be included in the polymerizable components are classified as high T_{g} monomers based on the glass transition temperature of the corresponding homopolymers. The high T_{g} monomers often have a T_{g} greater than 30° C., greater than 40° C., or greater than 50° C. when homopolymerized (i.e., a homopolymer formed from the monomer has a T_{g} greater than 30° C., greater than 40° C., or greater than 50° C.). Some suitable high T_{g} alkyl (meth)acrylate monomers include, for example, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, and 3,3,5 trimethylcyclohexyl (meth)acrylate.

The amount of the alkyl (meth)acrylate incorporated into the (meth)acrylate polymer can be any suitable amount up to 100 weight percent based on the total weight of the (meth)acrylic polymerizable components. The amount can be, for example, up to 99 weight percent, up to 95 weight percent, up to 90 weight percent, up to 85 weight percent, up to 80 weight percent, up to 75 weight percent, up to 70 weight percent, up to 65 weight percent, up to 60 weight percent, up to 55 weight percent, up to 50 weight percent, or up to 45 weight percent. The amount of the alkyl (meth)acrylate is often at least 35 weight percent, at least 40 weight percent, at least 45 weight percent, or at least 50 weight percent.

If the alkyl (meth)acrylate is selected to include high T_{g} monomers, the amount of this monomer is often no greater than 40 weight percent based on the total weight of polymerizable components. That is, the amount can be in a range of 0 to 40 weight percent based on the total weight of polymerizable components. If higher amounts are used, the overall T_{g} of the (meth)acrylate polymer may be too high. The amount of the high T_{g} alkyl (meth)acrylate monomer is often no greater than 35 weight percent, no greater than 25 weight percent, or no greater than 15 weight percent. If present, the amount of the high T_{g} alkyl (meth)acrylate monomer is often at least 0.5 weight percent, at least 1 weight percent, at least 3 weight percent, at least 5 weight percent, or at least 10 weight percent. If the polymerizable component includes high T_{g} alkyl (meth)acrylate monomers, enough low T_{g} alkyl (meth)acrylate monomers is typically added to form a (meth)acylate polymer with a T_{g} no greater than 20° C.

The alkyl (meth)acrylate monomer is typically selected to include a low Tg monomer such as those that have a T_{g} no greater than −10° C. when measured as a homopolymer. For example, the polymerizable components often contain at least 40 weight percent, at least 45 weight percent, at least 50 weight percent, at least 55 weight percent, at least 60 weight percent, at least 65 weight percent, or at least 70 weight percent and up to 95 weight percent, up to 90 weight percent, up to 85 weight percent, up to 80 weight percent, up to 75 weight percent, or up to 70 weight percent low T_{g} monomer having a T_{g} no greater than −10° C. when measured as a homopolymer. The amount is based on the total weight of polymerizable components.

Suitable alkyl monomers that have a T_{g} no greater than −10° C. when measured as a homopolymer include, but are not limited to, 2-ethylhexyl acrylate, isooctyl acrylate, N-butyl acrylate, 2-methylbutyl acrylate, 2-octyl acrylate, and combinations thereof.

In some embodiments, the (meth)acrylate polymer is substantially free of acidic monomers. As used herein to describe acidic monomers, the term “substantially free” means that the (meth)acrylate polymer contains less than 1 weight percent, less than 0.5 weight percent, less than 0.2 weight percent, or less than 0.1 weight percent of these monomers. In some embodiments, the crosslinkable composition may be substantially free of acid in order to eliminate indium tin oxide (“ITO”) and metal trace corrosion that otherwise could damage touch sensors and their integrating circuits or connectors.

The (meth)acrylate polymer typically has a glass transition temperature no greater than 15° C. as determined by Dynamic Mechanical Analysis. For example, the glass transition temperature can be no greater than 15° C., no greater than 10° C., no greater than 5° C., no greater than 0° C., or no greater than −5° C. The glass transition temperature is often greater than −50° C., greater than −40° C., or greater than −30° C.

In some preferred embodiments, the alkyl (meth)acrylate monomer may be selected from the group consisting of 2-ethylhexyl acrylate, 2-ethylhexyl methacrylate, hexyl acrylate, butyl acrylate, cyclohexyl acrylate, isobornyl (meth)acrylate, and combinations thereof.

### Additional Monomers

In some embodiments, the (meth)acrylate polymer may include a hydroxyl (meth)acrylate comonomer. Examples of suitable monomers include but are not limited to: 2-hydroxyethyl (meth)acrylate, and 2-hydroxy-propyl (meth)acrylate, 4-hydroxybutyl (meth)acrylate, and the like. In some embodiments, the (meth)acrylate polymer includes between about 0 and about 40 parts by weight of the hydroxy functional copolymerizable monomer, particularly between about 5 and about 35 parts, and more particularly between about 10 and about 30 parts.

In some embodiments, the (meth)acrylate polymer may include a non-hydroxy functional polar copolymerizable monomer. Examples of suitable non-hydroxy functional polar copolymerizable monomers include, but are not limited to: acrylic acid, methacrylic acid, itaconic acid, fumaric acid, ether functional monomers such as 2-ethoxyethyl (meth)acrylate, 2-ethoxyethoxyethyl (meth)acrylate, dimethylaminoethyl(meth)acrylate, nitrogen containing monomers such as acrylamide, methacrylamide, N-alkyl substituted and N,N-dialkyl substituted acrylamides or methacrylamides where the alkyl group has up to 3 carbons, and N-vinyl lactams. Examples of suitable substituted amide monomers include, but are not limited to: N,N-dimethylacrylamide, N,N-diethyl acrylamide, N-morpholino (meth)acrylate, N-vinyl pyrolidone and N-vinyl caprolactam. In some embodiments, the (meth)acrylate polymer includes between about 0 and about 20 parts by weight of the polar copolymerizable monomer, particularly between about 1 and about 15 parts, and more particularly between about 1 and about 10 parts.

In some embodiments, the (meth)acrylate polymer may include a vinyl ester, and particularly a C1 to C10 vinyl ester. An example of commercially available suitable vinyl esters include but are not limited to: vinyl acetate and VEOVA 9 or VEOVA 10 (available from Momentive Specialty Chemicals, New Smyrna Beach, Florida). The vinyl ester is typically added to the monomer mixture in an amount of between about 1 parts and about 20 parts by weight, particularly between about land about 15 parts, and more particularly between about 1 and about 10 parts. Other monomers, such as styrenic monomers may also be used.

In some embodiments, the (meth)acrylate polymer may include a polar (meth)acrylate monomer. Examples of suitable polar (meth)acrylate monomers include, but are not limited to: hydroxyethyl acrylate, hydroxypropyl acrylate, hydroxylbutyl acrylate, tetrahydrofuryl acrylate, acrylamide, N,N-dimethyl acrylamide, N-vinyl pyrrolidone, and acrylic acid. In some embodiments, the (meth)acrylate polymer includes between about 0 and about 50 parts by weight of the polar (meth)acrylate monomer, particularly between about 5 and about 45 parts, and more particularly between about 10 and about 40 parts.

In some embodiments, the (meth)acrylate polymer may include a monofunctional non-(meth)acrylate vinyl monomer. Examples of suitable monofunctional non-(meth)acrylate vinyl monomers include but are not limited to: N-vinyl pyrrolidone, N-vinyl carbazole, vinyl acetate, and vinyl ether. In some embodiments, the (meth)acrylate polymer includes between about 0 and about 15 parts by weight of the monofunctional non-(meth)acrylate vinyl monomer, particularly between about 1 and about 10 parts, and more particularly between about 1 and about 8 parts.

In some embodiments, the (meth)acrylate polymer may include a multifunctional (meth)acrylate monomer. Examples of useful multifunctional (meth)acrylate monomers include, but are not limited to, di(meth)acrylates, tri(meth)acrylates, and tetra(meth)acrylates, such as, for example, 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof. If used, the multifunctional (meth)acrylate monomer is typically used in an amount of at least 0.01, 0.02, 0.03, 0.04, or 0.05 up to 1, 2, 3, 4, or 5 parts by weight, relative to 100 parts by weight of the total monomer content.

In some preferred embodiments, the (meth)acrylate polymer may include 0 wt. % to 50 wt. % (e.g., 10 wt. % to 40 wt. %) of a polar (meth)acrylate monomer selected from the group consisting of hydroxyethyl acrylate, hydroxypropyl acrylate, hydroxylbutyl acrylate, tetrahydrofuryl acrylate, acrylamide, N,N-dimethyl acrylamide, N-vinyl pyrrolidone, acrylic acid, and combinations thereof; and 0 wt. % to 10 wt. % (e.g., 0 wt. % to 5 wt. %) of a monofunctional non-(meth)acrylate vinyl monomer selected from the group consisting of N-vinyl pyrrolidone, N-vinyl carbazole, vinyl acetate, vinyl ether, and combinations thereof.

### Polymerization Methods

Polymerization methods may include those activated thermally or by actinic radiation (e.g., actinic radiation in the visible and/or ultraviolet region of the electromagnetic spectrum). A free radical initiator is typically combined with the polymerizable components. Other optional components such as a chain transfer agent, antioxidant, solvent, and the like may be included in the polymerizable composition.

A free radical initiator, which can be either a photoinitiator or a thermal initiator, is typically used to form the (meth)acrylate polymer. Multiple photoinitiators or multiple thermal initiators can be used. The amount of the free radical initiator can influence the weight average molecular weight with larger amounts typically producing lower molecular weight polymeric materials. The amount of free radical initiator is usually at least 0.001 weight percent, at least 0.005 weight percent, at least 0.01 weight percent, at least 0.05 weight percent, at least 0.1, at least 0.5 weight percent, or at least 1.0 weight percent based on the total weight of polymerizable components. The amount can be up to 5 weight percent, up to 4 weight percent, up to 3 weight percent, up to 2 weight percent, up to 1.5 weight percent, up to 1 weight percent, up to 0.5 weight percent, up to 0.3 weight percent, up to 0.2 weight percent, or up to 0.1 weight percent based on the total weight of polymerizable components.

Suitable thermal initiators include various azo compound such as those commercially available under the trade designation VAZO from Chemours Co. (Wilmington, DE, USA) including VAZO 67, which is 2,2′-azobis(2-methylbutane nitrile), VAZO 64, which is 2,2′-azobis(isobutyronitrile), VAZO 52, which is (2,2′-azobis(2,4-dimethylpentanenitrile), and VAZO 88, which is 1,1′-azobis(cyclohexanecarbonitrile); various peroxides such as benzoyl peroxide, cyclohexane peroxide, lauroyl peroxide, di-tert-amyl peroxide, tert-butyl peroxy benzoate, di-cumyl peroxide, and peroxides commercially available from Atofina Chemical, Inc. (Philadelphia, PA, USA) under the trade designation LUPERSOL (e.g., LUPERSOL 101, which is 2,5-bis(tert-butylperoxy)-2,5-dimethylhexane, and LUPERSOL 130, which is 2,5-dimethyl-2,5-di-(tert-butylperoxy)-3-hexyne); various hydroperoxides such as tert-amyl hydroperoxide and tert-butyl hydroperoxide; and mixtures thereof.

In many embodiments, a photoinitiator is used to form the (meth)acrylate polymer. Some exemplary photoinitiators are benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Florham Park, NJ, USA) or under the trade designation ESACURE KB-1 from Sartomer (Exton, PA, USA)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators may include, for example, 1-hydroxycyclohexyl phenyl ketone (commercially available under the trade designation IRGACURE 184), phenylbis (2,4,6-trimethylbenzoyl) phosphineoxide (commercially available under the trade designation IRGACURE 819), 1-[4-(2-hydroxyethoxy)phenyl]-2-hydroxy-2-methyl-1-propane-1-one (commercially available under the trade designation IRGACURE 2959), 2-benzyl-2-dimethylamino-1-(4-morpholinophenyl) butanone (commercially available under the trade designation IRGACURE 369), 2-methyl-1-[4-(methylthio)phenyl]-2-morpholinopropan-1-one (commercially available under the trade designation IRGACURE 907), diphenyl (2,4,6-trimethylbenzoyl) phosphine oxide, obtained from IGM Resins USA Inc., Charlotte, North Carolina, and 2-hydroxy-2-methyl-1-phenyl propan-1-one (commercially available under the trade designation DAROCUR 1173 from Ciba Specialty Chemicals Corp. (Tarrytown, NY, USA)).

Sensitizers may also be used to enhance the efficacy of the photoinitiators in certain embodiments. Useful sensitizers may include, for example, isopropylthioxanthone (available under the trade name OMNIRAD ITX) and 4-diethyl-9H-thioxanthen-9-one (available under the trade name OMNIRAD DETX), as well as other thioxanthones based sensitizers.

Chain-transfer agents are often included in the polymerizable composition to control the molecular weight of the (meth)acrylate polymer. Suitable chain-transfer agents include, but are not limited to, those selected from the group of carbon tetrabromide, hexabromoethane, bromotrichloromethane, 2-mercaptoethanol, tert-dodecylmercaptan, isooctylthioglycoate, 3-mercapto-1,2-propanediol, cumene, pentaerythritol tetrakis(3-mercapto butyrate) (available under the trade name KARENZ MT PE1 from Showa Denko), 1,4-bis (3-mercaptobutylyloxy) butane (available under trade name KARENZ MT BD1 from Showa Denko), ethylene glycol bisthioglycolate, and mixtures thereof. Depending on the reactivity of the chain-transfer agent selected, the amount of chain transfer agent is often in a range of 0 to 5 weight percent based on the total weight of monomers in the polymerizable composition. In some embodiments, the amount of the chain transfer agent is at least 0.05 weight percent, at least 0.1 weight percent, at least 0.2 weight percent, at least 0.3 weight percent, or at least 0.5 weight percent and can be up to 5 weight percent, up to 4.5 weight percent, up to 4 weight percent, up to 3.5 weight percent, up to 3 weight percent, up to 2.5 weight percent, up to 2 weight percent, up to 1.5 weight percent, or up to 1 weight percent. The weight percent values are based on the total weight of the polymerizable components used to form the (meth)acrylate polymer.

The reaction of the polymerizable composition to form the (meth)acrylate polymer can occur in the presence or absence of an organic solvent. If an organic solvent is included in the polymerizable composition, the amount is often selected to provide the desired viscosity. Examples of suitable organic solvents include, but are not limited to: methanol, tetrahydrofuran, ethanol, isopropanol, pentane, hexane, heptane, acetone, methyl ethyl ketone, methyl acetate, ethyl acetate, toluene, xylene, and ethylene glycol alkyl ether. Those organic solvents can be used alone or as mixtures thereof.

In some embodiments, the polymerization occurs in the presence of at least 10 weight percent organic solvent based on a total weight of the polymerizable composition. The amount can be, for example, at least 20 weight percent, at least 30 weight percent, at least 40 weight percent and up to 70 weight percent, up to 60 weight percent, up to 50 weight percent. In other embodiments, the polymerization occurs with little or no organic solvent present. That is the polymerizable composition is free of organic solvent or contains a minimum amount of organic solvent. If used, the organic solvent is often present in amounts less than 10 weight percent, less than 5 weight percent, less than 4 weight percent, less than 3 weight percent, less than 2 weight percent, or less than 1 weight percent based on the total weight of the polymerizable composition.

The (meth)acrylate polymer can be formed from the polymerizable composition using any suitable method. The polymerization can occur in a single step or in multiple steps. That is, all or a portion of the monomers and/or free radical initiator may be charged into a suitable reaction vessel and polymerized. For example, a polymerizable composition containing an organic solvent and a thermal initiator can be mixed and heated at an elevated temperature such as in a range of 50° C. to 100° C. (e.g., 55° C. to 70° C.) for several hours.

In one possible method of making the (meth)acrylate polymer, little or no organic solvent is included in the polymerization composition. Such a free radical polymerization method can be conducted in a continuous manner as described, for example, in U.S. Pat. No. 4,619,979 (Kotnour et al.) and U.S. Pat. No. 4,843,134 (Kotnour et al.). In an alternative method of making the (meth)acrylate polymer, an adiabatic process can be used as described, for example, in U.S. Pat. No. 5,986,011 (Ellis et al.) and U.S. Pat. No. 5,637,646 (Ellis). In a yet other method of making the (meth)acrylate polymer, the polymerization reaction can occur within a polymeric package as described in U.S. Pat. No. 5,804,610 (Hamer et al.).

The resulting (meth)acrylate polymer may be un-crosslinked or crosslinked depending on the composition of the polymerizable composition. In some embodiments, the (meth)acrylate polymer is crosslinked. In some embodiments, the monomer mixture may include a multifunctional cross-linker. For example, the mixture may include thermal cross-linkers which are activated during the drying step of preparing solvent coated adhesives as well as cross-linkers that copolymerize during the polymerization step. Such thermal cross-linkers may include, but are not limited to: multifunctional isocyanates, multifunctional aziridines, and epoxy compounds. Exemplary cross-linkers which can be copolymerized include multifunctional acrylates such as 1,6-hexanediol diacrylate or multifunctional acrylates such as are known to those of skill in the art. In some embodiments, useful isocyanate cross-linkers may include, for example, an aromatic triisocyanate available as DESMODUR N3300 (Bayer, Cologne, Germany). Ultraviolet, or “UV” activated cross-linkers can also be used. Such UV cross-linkers may include non-copolymerizable photocrosslinkers, such as benzophenones and copolymerizable photocrosslinkers such as acrylated or methacrylated benzophenones like 4-acryloxybenzophenones. Typically, the cross-linker, if present, is added to the monomer mixture in an amount of between about 0.01 parts and about 5 parts by weight based, particularly between about 0.01 and about 4 parts, and more particularly between about 0.01 and about 3 parts. Other crosslinking methods, such as ionic crosslinking, acid-base crosslinking, or the use of physical crosslinking methods, such as by copolymerizing high T_{g} macromers, such as, for example, polymethylmethacrylate macromer or polystyrene macromer, may also be used. When included, macromers may be used in an amount of about 1 to about 20 parts by weight of the total monomer components.

### Acylphosphine Oxide Photoinitiators

The crosslinkable composition further comprises an acylphosphine oxide photoinitiator. Acylphospine oxide photoinitiators useful in embodiments of the present disclosure may include, for example, diphenyl(2,4,6-trimethylbenzoyl)phosphine oxide (“TPO”) commercially available from IGM Resins USA Inc., Charlotte, North Carolina and phenylbis(2,4,6-trimethylbenzoyl) phosphineoxide (“BAPO”), both commercially available from IGM Resins USA Inc., Charlotte, North Carolina.

In some embodiments, the acylphosphine oxide photoinitiator may include a mono-acylphosphine oxide (e.g., TPO) represented by the structure

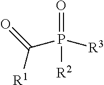

where R¹ is a light absorbing moiety (e.g., aromatic, substituted aromatic) and R² and R³ are independently light absorbing and/or solubilizing (e.g., alkyl) moieties.

In some preferred embodiments, the acylphosphine oxide photoinitiator may include a bis-acylphosphine oxide (e.g., BAPO) represented by the structure

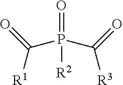

where R¹ is a light absorbing moiety (e.g., aromatic, substituted aromatic) and R² and R³ are independently light absorbing and/or solubilizing (e.g., alkyl) moieties.

In preferred embodiments, the crosslinkable composition comprises 0.05 pph to 5 pph (e.g., 1 pph) of the acylphosphine oxide photoinitiator with respect to the (meth)acrylate polymer mixture.

### (Meth)Allyl Crosslinking Monomer

The crosslinkable composition further comprises a crosslinking monomer comprising at least two terminal groups selected from allyl, (meth)allyl, or combinations thereof. An allyl group has the structural formula H₂C═CH—CH₂—. It consists of a methylene bridge (—CH₂—) attached to a vinyl group (—CH═CH₂). Similarly, a (meth)allyl group is a substituent with the structural formula H₂C═C(CH₃)—CH₂—.

In some embodiments, the crosslinking monomers are free of vinyl groups, such as vinyl ethers. Vinyl, also known as ethenyl, is the functional group —CH═CH₂, namely the ethylene molecule (H₂C═CH₂) minus one hydrogen atom.

In one embodiment, the crosslinking monomer comprise two (meth)allyl groups and a (meth)acrylate group. A crosslinking monomer of this type is commercially available from Sartomer, under the trade designation “SR 523”. In some embodiments, the crosslinking monomer is free of (meth)acrylate groups. The lower reactivity of the (meth)allyl group, as compared to a (meth)acrylate group, can be amendable to achieving an optimal amount of crosslinking, especially when the adhesive is cured by (e.g., UV) radiation.

The crosslinking monomer typically has the formula

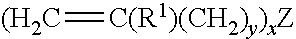

wherein R¹ is hydrogen or methyl, Z is a heteroatom or multivalent linking group, and
x ranges from 2 to 6. In some embodiments, y is 5-20. In some embodiments, x is 2 or 3.

For embodiments wherein the crosslinking monomer comprises a multivalent linking group, the linking group, Z, typically has a molecular weight no greater than 1000 g/mole and in some embodiments no greater than 500 g/mole, 400 g/mole, 300 g/mole, 200 g/mole, 100 g/mole, or 50 g/mole.

Various crosslinking monomers comprising at least two allyl and/or (meth)allyl groups are commercially available. Representative species of commercially available crosslinking monomers are described in the following Table A. Although these species comprise allyl groups, in many embodiments the same species with (meth)allyl groups are available or can be synthesized. For example, (meth)allyl adipate can be prepared in the manner described in U.S. Patent Pub. 2017/0037282 (Lipscomb et al.).

TABLE A

| Name | Formula |
|---|---|
| allyl ether | 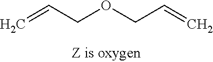 |
| triallyl amine | 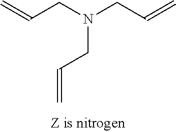 |
| 1,11-dodecadiene | 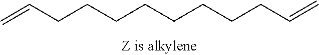 |
| ethylene glycol diallyl ether | 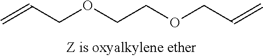 |
| diallyl adipate | 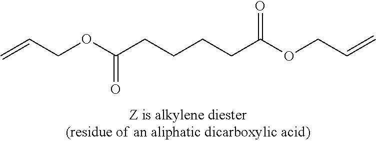 [SMILES: C=CCOC(=O)CCCCC(=O)OCC=C] |
| diallyl sebacate | 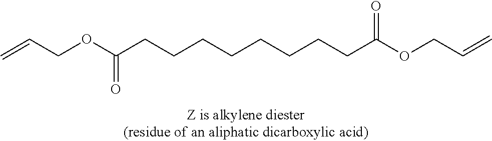 [SMILES: C=CCOC(=O)CCCCCCCCC(=O)OCC=C] |
| diallyl maleate | 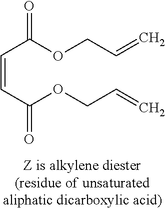 |
| diallyl terephthalate | 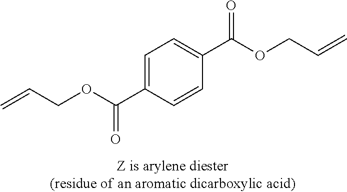 [SMILES: C=CCOC(=O)c1ccc(C(=O)OCC=C)cc1] |
| diallyl isophthalate | 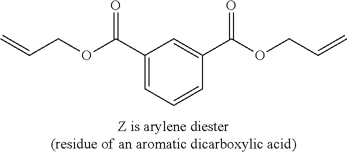 [SMILES: C=CCOC(=O)c1cccc(C(=O)OCC=C)c1] |
| triallyl cyanurate | 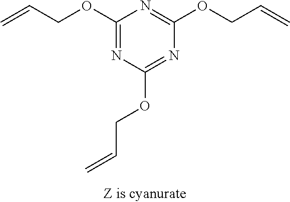 [SMILES: C=CCOc1nc(OCC=C)nc(OCC=C)n1] |
| triallyl isocyanurate | 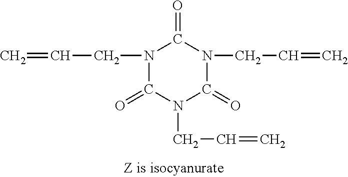 [SMILES: C=CCn1c(=O)n(CC=C)c(=O)n(CC=C)c1=O] |
| trimethylolpropane diallyl ether | 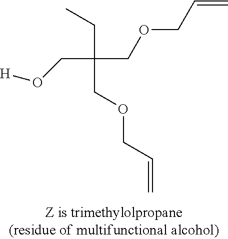 |
| pentaerythritol allyl ether | 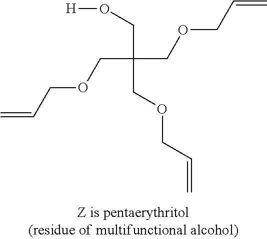 [SMILES: C=CCOCC(CO)(COCC=C)COCC=C] |
| 1,3-diallyl urea | 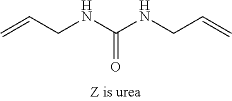 |
| diallyl carbonate | 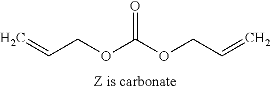 |
| dially(dimethyl)silane | 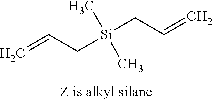 |

Crosslinking monomers comprising at least two allyl and/or (meth)allyl groups can also be synthesized in accordance with various reaction schemes known in the art.

In one reaction scheme, an aryl or heteroaryl magnesium compound can be reacted with an allylic halide (e.g., bromine) as described in Krasovskiy, Straub, and Knochel; Angewandte Chemic—International Edition, 2006, vol. 45, p. 159-162. Suitable allylic halides include for example allyl chloride, allyl bromide, allyl iodide, 4-bromo-1-butene, 3-chloro-2-methyl propene, 3-bromo-2-methyl propene, 5-bromo-1-pentene, 6-bromo-1-hexene, 8-bromo-1-octene, 10-chloro-1-decene, and 11-chloro-1-undecene. Such reaction scheme can produce for example diallyl benzene, depicted as follows:

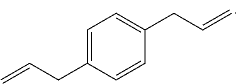

In this embodiment, the multivalent linking group, Z, is arylene.

Various reaction schemes for preparing the crosslinking monomers described herein utilize an (meth)allylic alcohol as a starting material. Thus, the (meth)allyl groups are the reaction product of an allylic or (meth)allylic alcohol.

Various (meth)allylic alcohols can be used in such reaction schemes including for example allyl alcohol 2-methyl-2-propen-1-ol, 2-ethyl-2-propen-1-ol, 2-pentyl-2-propen-1-ol, 10-undecen-1-ol, 3-buten-1-ol, 3-methyl-3-buten-1-ol, 4-penten-1-ol, 5-hexen-1-ol, 9-decen-1-ol and 2-allyloxyethanol. In some embodiments, the crosslinking monomer is a reaction product of a (meth)allylic alcohol comprising at least 8, 9 or 10 carbon atoms. Such alcohols typically comprise (meth)allyl group and an alkylene group comprising at least 5, 6, 7, or 8 carbon atoms and typically no greater than 20, 18 or 16 carbon atoms. In some embodiments, the (meth)allylic alcohol comprises no greater than 12 carbon atoms, and thus comprises an alkylene group with no greater than 9 carbon atoms. Thus, in various embodiments wherein Z comprises an alkylene group, the alkylene group may comprise at least 5, 6, 7, or 8 carbon atoms and typically no greater than 20, 18 or 16 carbon atoms.

Various alkoxylated allylic alcohols can also be used in such reaction schemes. Suitable alkoxylated allylic alcohols have the general formula:

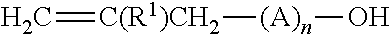

wherein R¹ is hydrogen or methyl; A is a C₂-C₄ oxyalkylene group and especially C₂H₄O— optionally in combination with C₃H₆O—; and n typically averages 1 to 5. In this embodiment, Z comprises or consists of an oxyalkylene group or a polyoxyalkylene group. One representative compound is ethylene glycol diallyl ether, shown in Table A.

In other embodiments, Z comprises a (e.g. single) ether group and alkylene groups. The crosslinking monomer may have the formula

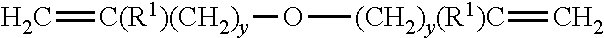

wherein y ranges from 2-20; and R¹ is hydrogen or methyl. In some embodiments, y is at least 5, 6, 7, or 8. Such crosslinking monomers can be prepared by reaction of an allylic alcohols, as previously described, or thiols as described in Marvel and Cripps; Journal of Polymer Science, 1952, vol. 8, p. 313-320. One illustrative reaction scheme utilizing 10-undecen-1-ol to produces undecenyl ether, depicted as follows:

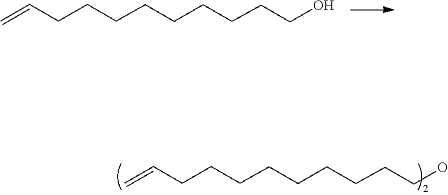

In other embodiments, Z is a reaction product of a multifunctional alcohol having 2 to 6 hydroxyl groups. In this embodiment, the crosslinking monomer typically has the formula

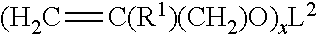

wherein L² is a linear or branched (C₁-C₁₂) alkylene optionally comprising one or more substituents such as hydroxyl groups or alkoxy groups; x ranges from 2 to 6; and R¹ is hydrogen or methyl. In some embodiments, x is at least 2, such as in the case of butane diol (meth)ally ether. In other embodiments, x is at least 3 and L² is a residue of a multifunctional alcohol such as glycerol, trimethylolpropane, trimethylolpropane ethoxylate, trimethylolpropane propoxylate, pentaerythritol, 1,2,4-butanetriol, 1,1,1-tris(hydroxymethyl)ethane, fructose, glucose, 1,3,5-tris(2-hydroxyethyl)isocyanurate, dipentaerythritol, and di(trimethylolpropane). Representative examples of such crosslinking monomers include for example trimethylolpropane diallyl ether and pentaerythritol allyl ether depicted above in Table A.

In yet other embodiments, Z comprises or consists of an ester group. In some embodiments, the crosslinking monomer comprises a single ester group, typically bonded to a C₁-C₂₀ alkylene group and in some embodiments a (C₁-C₁₂) alkylene group. Such crosslinking monomer can be prepared by the reaction of (meth)allylic alcohols, as previously described, with (meth)allylic acids, as described for example in Frostick et al., Journal of the American Chemical Society, 1959, vol. 81, p. 3350-3352. When (meth)allylic acids are utilized as the starting material for producing the (meth)allyl group(s) of the crosslinking monomer, the acid is chosen such that the double bond is spaced from the acid group by a (C₁-C₂₀) alkylene group. Representative acids include for example 3-butenoic acid, 4-pentenoic acid, 2,2-dimethyl-4-pentenoic acid, 5-hexenoic acid, 6-heptenoic acid, 9-decenoic acid, and 10-undecenoic acid. One illustrative reaction scheme is as follows:

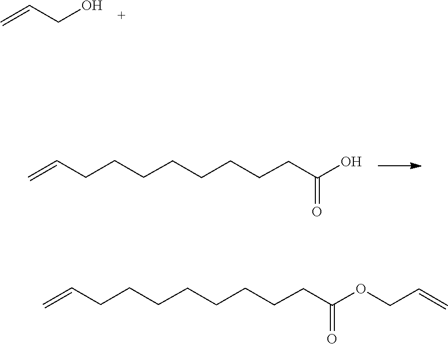

In other embodiments, Z comprises more than one ester group (e.g. diester). In this embodiment, the crosslinking monomer typically has the formula

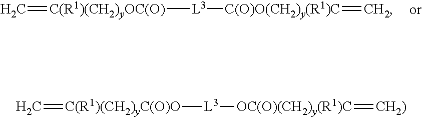

wherein R¹ is hydrogen or methyl; L³ is (e.g. C₁-C₂₀) alkylene, arylene, or a combination thereof; and y ranges from 1 to 20. In some embodiments, y is at least 5, 6, 7, or 8.

Such crosslinking monomers are typically the residue of an aliphatic or aromatic dicarboxylic acid or diol. Representative examples of such crosslinking monomers include di(meth)allyl sebacate, di(meth)allyl adipate, di(meth)allyl terephthalate, di(meth)allyl isophthalate; the dially structures depicted in Table A. Others examples include di(meth)allyl itaconate, di(meth)allyl maleate, di (meth)allyl fumarate, di(meth)allyl diglycolate, di(meth)allyl oxalate, di(meth)allyl succinate, and 1,4-butanediol di(undecenylate) depicted as follows:

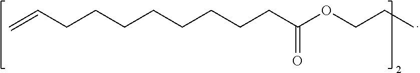

In yet other embodiments, Z comprises or consists of an amide group. In some embodiments, the crosslinking monomer comprises a single amide group, typically bonded to a (C₁-C₂₀) alkylene group and in some embodiments a C₁-C₁₂ alkylene group. In this embodiment, the crosslinking monomer typically has the formula

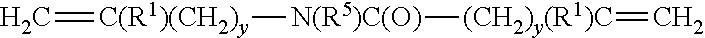

wherein R¹ is hydrogen or methyl; R⁵ is hydrogen, (C₁-C₆) alkyl, or aryl; and
y ranges from 1 to 20. In some embodiments, y is at least 5, 6, 7, or 8.

Such crosslinking monomers can be prepared by the reaction of (meth)allylic acids, as previously described, with allylic amines, as described for example in Goldring, Hodder, Weiler; Tetrahedron Letters, 1998, vol. 39, #28 p. 4955-4958. Representative amines include for example allyl amine, N-methyl allylamine, diallyl amine, triallyl amine, tris(2-methallylamine), and N-allyl cyclohexylamine. One illustrative reaction scheme is as follows:

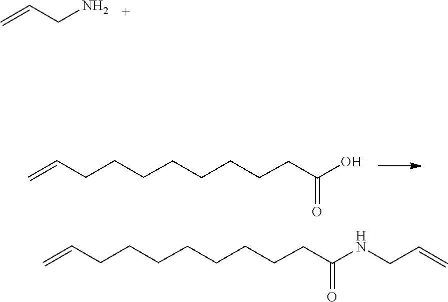

In yet another embodiment, (meth)allylic acids, as previously described can be reacted with a diamine. Conversely, the previously described allylic amines can be reacted with a dicarboxylic or tricarboxylic acid. In this embodiment, Z comprises more than one (e.g. 2 or 3) amide groups. In this embodiment, the crosslinking monomer typically has the formula

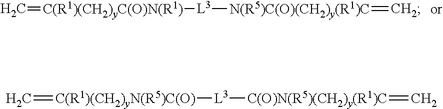

wherein R¹ is hydrogen or methyl; R⁵ is hydrogen, (C₁-C₆) alkyl, or aryl; L³ is (e.g. C₁-C₂₀) alkylene, arylene, or a combination thereof; and y ranges from 1 to 20. In some embodiments, y is at least 5, 6, 7, or 8.

One representative structure is N,N′-butanediyl-bis-undecenylamide, depicted as follows:

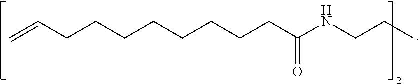

In view of the various crosslinking monomers described herein Z can be a heteroatom, such as nitrogen or oxygen, as well as a wide variety of multivalent (e.g., di-, tri-) linking groups. Z can comprise for example (C₁-C₂₀ or C₅-C₂₀) alkylene, arylene, oxyalkylene (e.g., polyoxyalkylene), ester (e.g., monoester, diesters, residues of aliphatic and aromatic carboxylic acids), ether (e.g., residues of multifunctional alcohols), cyanurate, isocyanurate, amide, amine urea, urethane, carbonate, and (C₁-C₄ alkyl) silane. In some embodiments, Z comprises only one of such multivalent linking groups. In other embodiments, Z comprises more than one of the same class of multivalent linking groups (e.g. diester, triether). In yet other embodiments, Z comprises combinations of different classes of multivalent linking groups such as an ester, ether, carbonate, amide, urea, or urethane and an (C₁-C₂₀ or C₁-C₅) alkylene or arylene group.

The concentration of crosslinking monomer comprising at least two (meth)allyl groups is typically 0.05 pph to 5 pph (e.g., 0.1 pph) with respect to the (meth)acrylate polymer mixture.

In some preferred embodiments, the crosslinking monomer may be represented by the structure (I)

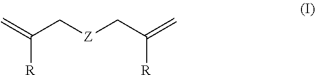

where Z represents a divalent connecting group and each R is independently —H or —CH₃. In some preferred embodiments Z is connected by at least one of an ester linkage, an acetate linkage, and an amide linkage to the allyl groups of the multifunctional allyl terminated monomer. In some preferred embodiments Z is represented by the structure

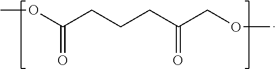

In some preferred embodiments Z is represented by the structure

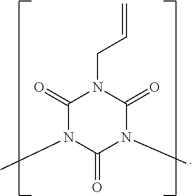

The crosslinkable composition may optionally comprise another crosslinker in addition to the crosslinker comprising at least two (meth)allyl groups. In some embodiments, the crosslinkable composition comprises a multifunctional (meth)acrylate. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof.

Generally, the multifunctional (meth)acrylate is not part of the original monomer mixture but added subsequently after the formation of the (meth)acrylic polymer. If used, the multifunctional (meth)acrylate is typically used in an amount of at least 0.01, 0.02, 0.03, 0.04, or 0.05 up to 1, 2, 3, 4, or 5 parts by weight, relative to 100 parts by weight of the total monomer content.

### UV Absorbers and Antioxidants

In some embodiments additives can be included in the crosslinkable composition such as, for example, ultraviolet (“UV”) absorbers (e.g., benzotriazole, substituted triazine, oxazolic acid amide, benzophenone, or derivatives thereof), ultraviolet stabilizers (e.g., hindered amines or derivatives thereof, imidazole or derivatives thereof, phosphorous-based stabilizers, and sulfur ester-based stabilizers), and/or antioxidants (e.g., hindered phenol compounds, phosphoric esters, or derivatives thereof). Exemplary antioxidants include those available from Ciba Specialty Chemicals Incorporated, Tarrytown, New York.

In some embodiments, the crosslinkable composition comprises an ultraviolet absorber such as, for example, 2-(2H-Benzotriazol-2-yl)-6-(1-methyl-1-phenylethyl)-4-(1, 1, 3, 3-tetramethylbutyl) phenol (commercially available as TINUVIN 928 from BASF, Florham Park, New Jersey) at a concentration of at least 0.25, 0.5, 1, 1.5, 2, 2.5, 3, 3.5, 4, 4.5, or 5 wt. % of the crosslinkable composition. The concentration of the ultraviolet absorber is typically no greater than 15, 14, 13, 12, or 10 wt. %. In some preferred embodiments, the concentration of the UV absorber ranges from 0.3 pph to 15 pph with respect to the (meth)acrylate polymer.

In some embodiments, the inclusion of the ultraviolet absorber can reduce the transmission (e.g. of a 100 microns thick adhesive layer) at 380 nm and 385 nm to less than 20, 15, 10, 9, 8, 7, 6, 5, 4, 3, or 2%. In some preferred embodiments the UV absorber has lower than 15% transmittance at 365 nm for a 0.1 mm thick coating. In some preferred embodiments the UV absorber has higher than 70% transmittance at 420 nm for a 0.1 mm thick coating.

### Optional Additives

Various other optional components can be added to the crosslinkable composition and/or to the adhesive as described below, such as, for example, adhesion promoters (e.g., (3-glycidyloxypropyl)trimethoxysilane or (3-glycidyloxypropyl)triethoxysilane), colorants (e.g., titania or carbon black), dyes, corrosion inhibiters (e.g., benzotriazole), antistatic agents, plasticizers, thickeners, thixotropic agents, processing aides, nanoparticles, fibers, and combinations thereof. Generally, the amounts of each additive would depend on the intended use of the resulting composition.

### Adhesive

An adhesive composition is provided that includes the crosslinkable composition as described above. In some embodiments, the adhesive composition is a pressure-sensitive adhesive. The (meth)acrylate polymer itself may have adhesive properties suitable for performing as a pressure-sensitive adhesive. Alternatively, optional additives such as a tackifier may be combined with the crosslinkable composition to provide a composition with suitable adhesive properties. Useful tackifiers include, for example, rosin ester resins and terpene phenol resins. Tackifiers are often mixed in an amount that is less than or equal to the amount of the (meth)acrylate-based polymeric material included in the core. The amount of the optional tackifier is often in a range of 0 to 25 weight percent, 0 to 20 weight percent, 0 to 15 weight percent, 0 to 10 weight percent, or 0 to 5 weight percent based on the total weight of the polymerizable composition.

Optional antioxidants and/or stabilizers such as hydroquinone monoethyl ether (p-methoxyphenol, MeHQ) and that available under the trade designation IRGANOX 1010 (pentaerythritol tetrakis(3-(3,5-di-tert-butyl-4-hydroxyphenyl)propionate)) from BASF Corp. (Florham Park, NJ, USA) can be added to increase the temperature stability of the polymeric material. If used, the antioxidant and/or stabilizer is typically added in a range of 0.01 weight percent to 1.0 weight percent based on a total weight of the polymerizable components used to form the (meth)acrylate polymer.

In some preferred embodiments the adhesive composition is a pressure-sensitive adhesive. In some preferred embodiments, the adhesive composition has a haze value of less than 5%, less than 2%, or less than 1% for a 0.1 mm thick coating.

### Articles

Articles are provided that include the adhesive composition and a substrate. Any suitable substrate can be used. In many embodiments, a layer of the adhesive composition is positioned adjacent to the substrate. The adhesive composition may directly contact the substrate or may be separated from the substrate by one of more layers such as a primer layer.

Any suitable substrate can be used. In some articles, the substrate is flexible. Examples of flexible substrate materials include, but are not limited to, polymeric films, woven or nonwoven fabrics; metal foils, foams (e.g., polyacrylic, polyethylene, polyurethane), and combinations thereof (e.g., metalized polymeric film). Polymeric films include, for example, polypropylene (e.g., biaxially oriented), polyethylene (e.g., high density or low density), polyvinyl chloride, polyurethane (e.g., thermoplastic polyurethanes), polyester (e.g., polyethylene terephthalate (“PET”), polyethylene naphthalate (“PEN”), and polylactic acid copolymer), polycarbonate, polyacrylate, polymethyl(meth)acrylate (“PMMA”), polyvinylbutyral, polyimide, polyamide, fluoropolymer, cellulose acetate, triacetyl cellulose (TAC), ethyl cellulose, and polycyclic olefin polymers (“COP”). The woven or nonwoven fabric may include fibers or filaments of synthetic or natural materials, such as cellulose, cotton, nylon, rayon, glass, ceramic materials, and the like.

In some embodiments, the article is or contains an adhesive tape. Examples of such adhesive tapes include transfer tapes, one-sided adhesive tapes, two-sided tapes (i.e., a core substrate with an adhesive layer on each side of the substrate, or die-cut adhesive articles (e.g., the article has an adhesive layer positioned adjacent to one release liner or positioned between two release liners). Such adhesive tapes may include a wide variety of substrates for use as a backing or release liner. Examples include woven and nonwoven materials, plastic films, metal foils, and the like.

Adhesive tapes are often prepared by coating an adhesive composition upon a variety of flexible or inflexible backing materials and/or release liners using conventional coating techniques to produce a one-sided tape or a two-sided tape. In the case of a one-sided adhesive tape, the adhesive composition can be coated on a layer of backing material and the side of the backing material opposite that where the adhesive is disposed can be coated with a suitable release material (e.g., a release layer or release liner). Release materials are known and include materials such as, for example, silicone, polyethylene, polycarbamate, polyacrylics, and the like. For two-sided adhesive tape, a first adhesive composition is coated on a layer of backing material and a second layer of adhesive composition is disposed on the opposing surface of the backing material. The second layer may include the adhesive compositions as described herein or a different adhesive composition. For a die-cut adhesive article or for a transfer tape, the adhesive composition is typically positioned between two release liners.

The adhesive articles can be part of another article. For example, the adhesive composition can bind two parts of an article together. In some such articles, the adhesive is positioned adjacent to a substrate that is flexible and/or foldable and is used within another article that is flexible and/or foldable such as within an electronic device that is flexible and/or foldable.

In some embodiments, the article containing the adhesive composition is part of an electronic device. In such devices, the adhesive composition typically forms a layer between two substrates for binding of the two substrates together. Examples of suitable substrates include materials such as polyacrylate, polymethyl methacrylate, polycarbonate, polyamide, polyimide, polyethylene terephthalate (“PET”), polyethylene naphthalate (“PEN”), polycyclic olefin polymers (COP), thermoplastic polyurethane, triacetyl cellulose (“TAC”), and metal foil.

A common application of adhesives in the electronics industry is in the manufacturing of various displays, such as, for example, computer monitors, televisions, cell phones, tablets, and small displays (in cars, appliances, wearables, electronic equipment, etc.). With the continued development of electronic displays, there is an increasing demand for adhesives, and particularly for optically clear adhesives (“OCA”), to serve as an assembly layer or gap filling layer between an outer cover lens or sheet (based on glass, polyethylene terephthalate (“PET”), polycarbonate (“PC”), polymethyl methacrylate (“PMMA”), polyimide, polyethylene naphthalate (“PEN”), cyclic olefin copolymer, etc.) and an underlying display module of electronic display assemblies. The presence of the OCA may improve the performance of the display by increasing brightness and contrast, while also providing structural support to the assembly. The adhesive compositions described herein can be prepared to be an OCA.

The article may be formed by positioning an adhesive layer adjacent to a substrate. The adhesive composition can be coated on a substrate (e.g., a backing or a release liner) using conventional coating techniques. For example, the adhesive compositions can be applied by methods such as roller coating, flow coating, dip coating, spin coating, spray coating, knife coating, and die coating. The adhesive composition that is coated may have any desirable weight percent solids but is often in a range of 10 to 100 weight percent solids based on the total weight of the adhesive composition. The desired solids content may be achieved by further dilution of the coating composition, or by partial drying.

The adhesive composition positioned on a substrate as a layer or positioned between two release liners as a layer often has a thickness up to 100 micrometers (i.e., microns or μm), up to 50 micrometers, up to 35 micrometers, or up to 25 micrometers. In some embodiments, the adhesive composition may have an overall (average) thickness of the adhesive composition disposed on a substrate in a layer (e.g., in the form of a coating placed between liners) of up to 500 micrometers, up to 400 micrometers, up to 300 micrometers, or up to 200 micrometers. In some embodiments, the adhesive composition may have an overall (average) thickness of the adhesive composition disposed on a substrate in a layer (e.g., in the form of a coating placed between liners) of at least 5 micrometers, at least 10 micrometers, or at least 15 micrometers. The thickness that is desirable is dependent on the specific use of the adhesive layer.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted or readily apparent from the context, all parts, percentages, ratios, etc. in the Examples and the rest of the specification are by weight.

TABLE 1
Materials Used in the Examples

| Abbreviation | Description |
|---|---|
| TPO | Diphenyl(2,4,6-trimethylbenzoyl)phosphine oxide, |
| | obtained from IGM Resins USA Inc., Charlotte, |
| | North Carolina |
| BAPO | Phenylbis(2,4,6-trimethylbenzoyl)phosphineoxide), |
| | obtained from IGM Resins USA Inc., Charlotte, |
| | North Carolina |
| TINUVIN 928 | 2-(2H-Benzotriazol-2-yl)-6-(1-methyl-1-phenylethyl)- |
| | 4-(1,1,3,3-tetramethylbutyl) phenol, obtained under |
| | the trade designation “TINUVIN 928” from BASF, |
| | Florham Park, New Jersey |
| DAAP | Diallyl adipate, obtained from TCI America, Portland, |
| | Oregon |
| HDDA | 1,6-hexanediol diacrylate, obtained from Alfa Aesar, |
| | Haverhill, Massachusetts |
| TAIC | Triallyl isocyanurate, obtained from TCI America, |
| | Portland, Oregon |
| IRG 651 | 2,2-dimethoxy-2-phenylacetophenone, obtained under the |
| | trade designation “IRGACURE 651” from Alfa Aesar, |
| | Haverhill, Massachusetts |
| EHA | 2-ethylhexyl acrylate, obtained from BASF, Florham |
| | Park, New Jersey |
| THFA | Tetrahydrofuryl acrylate, obtained from TCI America, |
| | Portland, Oregon |
| EHMA | 2-ethylhexyl methacrylate, obtained from Lucite |
| | International, Memphis, Tennessee |
| HEA | Hydroxyethyl acrylate, obtained from KOWA American |
| | Corporation, New York, New York |
| AcM | Acrylamide, obtained from Alfa Aesar, Haverhill, |
| | Massachusetts |
| — | Ethyl acetate, obtained from EMD Milipore Corporation, |
| | Burlington, Massachusetts |
| — | Isopropanol, obtained from VWR International, LLC, |
| | Radnor, Pennsylvania |

### Test Methods

### Gel Fraction Test

The gel fraction of adhesive films was characterized by gravimetric methods. Circular samples of both polymerized as well as polymerized and cured adhesive films (thickness: 0.1 mm, sample diameter: 25 mm) were loaded in a porous stainless steel container (McMaster-Carr, Elmhurst, Illinois; mesh size: 0.5 mm, width×length×height: 40 mm×40 mm×30 mm) with known mass. The mesh container and adhesive film were weighed and then immersed in a glass jar (diameter×height: 70 mm×85 mm) comprising a 1:1 v/v mixture of ethyl acetate/isopropanol (about 60 mL). After 24 hours, the metallic container and remaining adhesive film were taken out of the solvent jar and dried in a convection oven (DESPATCH, Minneapolis, MN) at 120° C. for 3 hours to provide the adhesive film after solvent incubation and drying. The masses of the adhesive films before and after solvent-incubation were recorded after subtracting the mass of the empty cage from each value. Two gel fraction tests were run for each sample and the gel fraction values were averaged.

The gel fraction of each adhesive film was calculated as follows:

$$\\ Gel Fraction = \frac{\begin{matrix}final mass of the adhesive film after \\ solvent incubation and drying\end{matrix}}{initial mass of the adhesive film}$$

### Optical Measurements

Haze and transmission measurements were made using an ULTRASCANPRO Spectrophotometer (HunterLab, Reston, Virginia) in transmission mode. For measured samples, 0.1 mm thick coated adhesive layer between release-coated carrier liners as described in the Examples below was cut to approximately 5 cm width by 10 cm length. One of the carrier liners was removed and the sample was laminated to a clear piece of 1 mm thick LCD glass (Swift Glass, Elmira Heights, New York). The other liner was then removed, and the sample was placed in the ULTRASCANPRO Spectrophotometer to measure transmission and color through the glass/OCA assembly. Haze and transmission at specific wavelengths were recorded and listed in Table 3 below.

### Examples

### General Procedure

A base polymer solution was prepared by partially UV-polymerizing a monomer mixture of EHA/THFA/EHMA/HEA/AcM with a weight ratio of 55.8/14.6/8.3/17.7/3.6 and IRG 651 photoinitiator added at 0.15 pph with respect to 100 parts of the monomer mixture in a clear jar. The mixture was inerted by flowing nitrogen gas into the jar before irradiating the mixture using a light source with an output wavelength at 365 nm and an intensity of 0.3 mW/cm² until a viscous solution of approximately 2,000 cP was achieved. After this first polymerization, the viscous solution was further mixed with TINUVIN 928 (1.8 pph), as well as additional photoinitiator and crosslinker as indicated in Table 2. The solution was coated in between siliconized PET films (RF02N and RF22N, available from SKC Hass, Seoul, South Korea) at 0.1 mm coating thickness and further polymerized (i.e., the second polymerization) using a light source at 405 nm and an output dose of approximately 200 mJ/cm² to form the adhesive film. Finally, samples were cured by exposing the adhesive film using a Fusion UV Processor (Fusion UV Systems Inc., Gaithersburg, MD) with D-bulb with a target dose of approximately 3,000 mJ/cm² of UVA as measured by a UVI Cure Power Puck 2 (EIT, Sterling, Virginia).

TABLE 2
Experimental Results Varying Crosslinker with D-bulb Second Cure with BAPO or TPO Photoinitator

| | | | Second | | | | |
|---|---|---|---|---|---|---|---|
| | | | Polymerization | | | | |
| | Crosslinker | Crosslinker | Photoinitiator | Photoinitiator | Gel Fraction | Gel Fraction | Change in |
| Example | Identity | Amount (pph) | Identity | Amount (pph) | (before cure) | (after cure) | Gel Fraction |
| CE-1 | — | 0 | BAPO | 1.0 | 0.12 | 0.16 | 0.04 |
| CE-2 | HDDA | 0.15 | BAPO | 1.0 | 0.61 | 0.63 | 0.02 |
| CE-3 | HDDA | 0.2 | BAPO | 1.0 | 0.69 | 0.70 | 0.02 |
| EX-1 | DAAP | 0.5 | BAPO | 1.0 | 0.24 | 0.41 | 0.17 |
| EX-2 | DAAP | 1 | BAPO | 1.0 | 0.47 | 0.60 | 0.14 |
| EX-3 | DAAP | 1.5 | BAPO | 1.0 | 0.58 | 0.67 | 0.09 |
| EX-4 | DAAP | 2 | BAPO | 1.0 | 0.67 | 0.74 | 0.08 |
| EX-5 | DAAP | 2.5 | BAPO | 1.0 | 0.70 | 0.77 | 0.07 |
| EX-6 | TAIC | 0.5 | BAPO | 1.0 | 0.53 | 0.65 | 0.11 |
| EX-7 | TAIC | 1 | BAPO | 1.0 | 0.68 | 0.77 | 0.09 |
| EX-8 | TAIC | 2 | BAPO | 1.0 | 0.84 | 0.86 | 0.03 |
| EX-9 | HDDA | 0.2 | TPO | 1.0 | 0.77 | 0.78 | 0.01 |
| EX-10 | HDDA | 0.3 | TPO | 1.0 | 0.8 | 0.84 | 0.04 |
| EX-11 | DAAP | 1.5 | TPO | 1.0 | 0.68 | 0.72 | 0.04 |
| EX-12 | DAAP | 2.5 | TPO | 1.0 | 0.75 | 0.79 | 0.04 |
| EX-13 | TAIC | 0.5 | TPO | 1.0 | 0.68 | 0.73 | 0.05 |
| EX-14 | TAIC | 1 | TPO | 1.0 | 0.78 | 0.82 | 0.04 |
| EX-15 | TAIC | 1.5 | TPO | 1.0 | 0.84 | 0.87 | 0.03 |

TABLE 3
UV/Vis Analysis Results on Selected OCA Films after Polymerization

| | Crosslinker | Transmittance | Transmittance | Transmittance | Transmittance | Haze |
|---|---|---|---|---|---|---|
| Example | Identity | (%) at 365 nm | (%) at 380 nm | (%) at 405 nm | (%) at 425 nm | % |
| CE-1 | — | 3.5 | 6.7 | 78.3 | 90.5 | 0.18 |
| EX-2 | DAAP | 3.0 | 6.5 | 78.5 | 90.7 | 0.12 |
| EX-7 | TAIC | 3.6 | 6.7 | 78.2 | 90.5 | 0.17 |

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A crosslinkable composition comprising:
a (meth)acrylate polymer comprising an alkyl (meth)acrylate monomer;
an acylphosphine oxide photoinitiator; and
a crosslinking monomer, the crosslinking monomer comprising at least two terminal groups selected from the group consisting of allyl, methallyl, or combinations thereof.

2. The crosslinkable composition of claim 1, wherein the (meth)acrylate polymer has a glass transition temperature no greater than 15° C.

3. The crosslinkable composition of claim 1, wherein the (meth)acrylate polymer comprises:
40 wt. % to 100 wt. % of the alkyl (meth)acrylate monomer;
0 wt. % to 50 wt. % of a polar (meth)acrylate monomer; and
0 wt. % to 15 wt. % of a monofunctional non-(meth)acrylate vinyl monomer.

4. The crosslinkable composition of claim 1, wherein the alkyl (meth)acrylate monomer is selected from the group consisting of 2-ethylhexyl acrylate, 2-ethylhexyl methacrylate, hexyl acrylate, butyl acrylate, cyclohexyl acrylate, isobornyl (meth)acrylate, and combinations thereof.

5. The crosslinkable composition of claim 1, wherein the polar (meth)acrylate monomer is selected from the group consisting of hydroxyethyl acrylate, hydroxypropyl acrylate, hydroxylbutyl acrylate, tetrahydrofuryl acrylate, acrylamide, N,N-dimethyl acrylamide, N-vinyl pyrrolidone, acrylic acid, and combinations thereof.

6. The crosslinkable composition of claim 1, wherein the monofunctional non-(meth)acrylate vinyl monomer is selected from the group consisting of N-vinyl pyrrolidone, N-vinyl carbazole, vinyl acetate, vinyl ether, and combinations thereof.

7. The crosslinkable composition of claim 1, wherein the (meth)acrylate polymer is substantially free of acidic monomer.

8. The crosslinkable composition of claim 1, wherein the acylphosphine oxide photoinitiator comprises a bis-acylphosphine oxide.

9. The crosslinkable composition of claim 1, wherein the crosslinkable composition comprises 0.05 pph to 5 pph of the acylphosphine oxide photoinitiator with respect to the (meth)acrylate polymer mixture.

10. The crosslinkable composition of claim 1, wherein the crosslinkable composition comprises 0.05 pph to 5 pph of the crosslinking monomer with respect to the (meth)acrylate polymer mixture.

11. The crosslinkable composition of claim 1, wherein the crosslinking monomer is represented by the structure 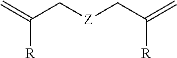
wherein
Z represents a divalent connecting group and each R is independently —H or —CH₃.

12. The crosslinkable composition of claim 1, wherein Z is represented by the structure

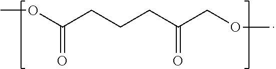

13. The crosslinkable composition of claim 1, wherein Z is represented by the structure

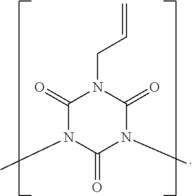

14. The crosslinkable composition of claim 1, wherein the crosslinkable composition further comprises a UV absorber.

15. The crosslinkable composition of claim 14, wherein the crosslinkable composition comprises from 0.3 pph to 15 pph of the UV absorber with respect to the (meth)acrylate polymer.

16. The crosslinkable composition of claim 14, wherein the UV absorber has lower than 15% transmittance at 365 nm for a 0.1 mm thick coating.

17. The crosslinkable composition of claim 14, wherein the UV absorber has higher than 70% transmittance at 420 nm for a 0.1 mm thick coating.

18. The crosslinkable composition of claim 1, further comprising an additive selected from the group consisting of adhesion promoters, antioxidants, colorants, dyes, corrosion inhibiters, antistatic agents, plasticizers, thickeners, thixotropic agents, processing aides, nanoparticles, fibers, and combinations thereof.

19. An adhesive composition comprising the crosslinkable composition of claim 1.

20. The adhesive composition of claim 19, wherein the adhesive composition is a pressure-sensitive adhesive.

21.-27. (canceled)
